(19) United States
(12) Patent Application Publication
(10) Pub. No.: US 2009/0099292 A1
(43) Pub. Date: Apr. 16, 2009

(54) FILLER SYSTEM AND PROCESS FOR MANUFACTURING CAST POLYMER PARTS

(75) Inventors: GREGORY S. NOVAK, TUCSON, AZ (US); JOHN PAUL SIMMONS, II, FARMINGTON HILLS, MI (US)

Correspondence Address: DALE F. REGELMAN, QUARLES & BRADY, LLP, ONE SOUTH CHURCH AVENUE AVE, STE. 1700, TUCSON, AZ, 85701-1621, US

(73) Assignee: ARIZONA CULTURED STONE PRODUCTS, INC., TUCSON, AZ (US)

(21) Appl. No.: 12/251,379

(22) Filed: Oct. 14, 2008

Related U.S. Application Data
(60) Provisional application No. 60/979,771, filed on Oct. 12, 2007.

(51) Int. Cl. C08K 3/10; C08K 3/34; C08L 33/12; B29C 43/02; A47B 96/18; C08K 3/26

(52) U.S. Cl. 524/435; 524/543; 524/443; 524/456; 524/450; 524/436; 524/452; 524/556; 312/140.3; 264/101

(57) ABSTRACT

A polymerizable composition comprising a monoethylenically unsaturated resin polymerizable by a free radical initiator, and a particulate formulation comprising one or more gemstones present in the particulate formulation at a level between about 0.5 weight percent to about 30 weight percent.

### CROSS-REFERENCE TO RELATED APPLICATIONS

This Application claims priority from a U.S. Provisional Application having Ser. No. 60,979,771, filed on Oct. 12, 2007.

### FIELD OF THE INVENTION

This invention relates to an engineered stone particulate formulation, and a process for forming cast polymer parts using that particulate formulation.

### BACKGROUND OF THE INVENTION

Prior art engineered stone products comprise a variety of mineral quartz materials, and are processed under elevated pressures. The materials used are largely quartz based and incorporate various natural and artificial colored stones, glass and minerals into their composition.

A prior art Breton Process utilizes elevated pressures, but requires a large capital expenditure for equipment. The elevated pressures are used to force a binding resin into a plurality of crevasses disposed in the surface of natural stone materials. This process reduces the resin content while making a stronger part. Without use of such elevated pressures, the resin would cure around an individual particle, but would not bond mechanically to the surface of that particle. The result of this process is a significantly weaker part.

Because of the density differences between a binding resin and the stone particulates, the larger mineral particulates settle to the bottom of a mold during vibration and the resin floats to the top. Resin-rich portions of a molded part shrink more during curing than do resin-poor portions, and therefore, part warpage often results using prior art formulations and methods.

### SUMMARY OF THE INVENTION

Applicants' invention includes a resin system comprising a particulate system that comprises one or more gemstones. The inclusion of gem stones offers a unique cosmetic look, and an aesthetic marketing appeal that current products on the market today do not offer. Utilizing high clarity crystals into several of the formulations allows for high translucency and back lighting effects to further enhance the cosmetic appeal of the product(s).

Applicants' invention further comprises a method of filling the naturally occurring stone fissures and crevasses with resin, without utilizing the elevated pressures of the Breton Process.

### DETAILED DESCRIPTION OF CERTAIN PREFERRED EMBODIMENTS

This invention is described in preferred embodiments in the following description with reference to the FIGS., in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

### Particulate Material Composition

Applicants' particulate formulation comprises a wide variety of minerals to achieve a desired color and texture. The appearance desired is obtained by blending colors and sizes.

Applicants' particulate formulation minimizes the amount of resin required to form a cast part. More specifically, Applicants' particulate formulation minimizes the total surface area of the particulate formulation, and also minimizes the number of matrix spaces that must be filled by resin. This later technique is referred to as “particle packing”.

Applicants' particulate formulation comprises one or more sized, semi-precious gemstones: In certain embodiments, the one or more gemstones are present in Applicants' particulate formulation, i.e. non-resin portion, at a level between about 0.5 weight percent to about 30 weight percent. In certain embodiments, the one or more gemstones are selected from the group comprising, but not limited to, citrine, lapis, Peridot, jade, garnet, amethyst, calcite, hematite, tiger's eye, citrine obsidian, garnet, and combinations thereof.

Applicants' particulate formulation, i.e. the non-resin portion, is present in an amount of at least 75 percent by weight and up to about 85 percent by weight of the polymerizable composition. In addition to the gemstones, in certain embodiments Applicants' particulate formulation further comprises additional fillers, such as for example, particles of unfilled and filled crosslinked or uncrosslinked polymeric material particles, known to the industry as “Poly Chips”. Such materials generally have a particle size of from about 325 to about 2 mesh (0.04-10.3 mm in greatest average dimension) and can be, for example, pigmented polyester or polymethyl methacrylate particles that may be filled with aluminum trihydrate or quartz.

In addition to the gemstones, in certain embodiments Applicants' particulate formulation further comprises pigments and dyes; reflective flakes; micas; metal particles; rocks; colored glass; colored sand of various sizes; sea shells; such as fibers, pellets and powders; and others. It is understood that the mineral can be modified such as with an organic material, to modify the rheology. A preferred glass such as for engineered stone-type products includes silica-based materials such as quartz, sand and glass. For engineered stone applications, the filler will generally be present in an amount at least 75% by weight and in many instances in an amount up to about 85% by weight of the total composition. The filler component may be comprised of any one filler or any combination of fillers.

The particle size of the filler may vary, and generally different particle sizes will be employed. Particle size and shape of the solid mineral components allows a desired casting mixture character and delivery of pleasing aesthetics and suitable physical performance. Mixtures of different particulate sizes and shapes can be used to enhance these properties. Additional components maybe added to the polymerizable compositions including those which are conventional in this area of technology.

In certain embodiments, compatibilizing agents may be added to improve the mixing of the compositions. Compatibilizing agents include but are not limited to emulsifiers, surfactants, detergents. Also, polymeric materials may be included which can be copolymers such as random, block and branched copolymers. The additional components can be present to add functional properties to the final polymerized article, and the components may be added solely for decorative or aesthetic properties such as pigments and colorants.

In certain embodiments, viscosity in the present invention is controlled due to a rapid reaction of a phosphoric ester component with an epoxide component, conventional sag control agents also known as gelling agents in the prior art may optionally be included. Examples are bis urea crystals; cellulose acetate butyrates (CAB); metal organic gellants such as aluminates, titanates, and zirconates; high aspect fibers; polymer powders; filler bridging agents; and fumed silica.

The casting resin used comprises a monoethylenically unsaturated moiety polymerizable by a free radical initiator, such as AIBN, methyl ethyl ketone peroxide, benzoyl peroxide, and the like. Monomers such as, for example and without limitation, include styrene, alkyl acrylates, alkyl methacrylates, acrylonitrile, acryl amides, mixtures thereof, and the like. In certain embodiments, Applicants' resin further comprises one or more epoxide resins, such as for example and without limitation, bis-phenol A di-epoxide, polyethylene oxide di-epoxide, polypropylene glycol di-epoxide, mixtures thereof, and the like.

Table I summarizes Applicant's molding composition.

TABLE 1

| COMPONENT | WEIGHT PERCENT RANGE |
|---|---|
| RESIN | 17-23 |
| Aluminum trihydrate (AlO₃) | 20-40 |
| Gemstones & Minerals | 60-80 |
| Quartz (SiO₂) | 1-10 of Gemstones/Minerals |
| | Weight |

### Preferred Method For Making Cast Engineered Quartz Products

Applicants' method requires a vessel comprising a port to inject a liquid resin under vacuum. Applicants' method comprises the following steps:

1. Applicants' particulate formulation filler is placed in a vacuum mixing vessel, and the internal pressure is lowered to 20-25 of vacuum.

2. The uninitiated or initiated liquid resin is injected into the vessel with or without the introduction of air. Monomers and other low molecular weight components will vaporize, thereby increasing the internal pressure to between 20 inches to 25 inches of mercury.

3. The resin and particulates are thoroughly mixed.

4. The vacuum is released and one or more polymerization initiators are added if this was not added prior.

5. The vacuum vessel is sealed, and the internal pressure is again reduced to just below the vapor pressure of the most volatile monomer used, i.e. the pressure whereat bubbles are observed to form in the resin/particulates/catalyst mixture.

6. The matrix is mixed under vacuum until the catalyst is homogenously dispersed in the matrix.

7. The vacuum is released and matrix cast into one or more molds.

8. The one or more molds are covered with a filter layer and a membrane and a vacuum is pulled on the top side of the mold. Excess resin is drawn out through the filter layer and out of the part. Vibration is applied to the mold during the vacuum drawdown process.

The use of Applicants' particulate formulation in combination with Applicants' method results in the following advances over the prior art:

1. The introduction of gemstones into an engineered stone particulate system offers unique visual and aesthetic properties that enhance the value of the cast engineered stone part.

2. The use of clear and semi clear, i.e. visually transparent, glass (non-crystalline materials) and crystals in many of the colors offered, allows for many of the finished parts to be translucent or semi-translucent which lends itself well to installations that utilize backlighting to reveal the gem stones. By “translucent materials,” Applicant means materials that allow light to pass through them only diffusely, i.e. actual image cannot be seen through the material.

3. Many ingredients used are bi-products of the gem and jewelry industry and can be considered recycled scrap materials.

4. While these formulations can be cast with or without a clear gel coat, the formulations are cosmetically optimized for casting materials in a mold where a clear gel coat layer is applied into the mold cavity prior to casting. This eliminated the need to score the surface of the finished part to reveal the colors of the minerals incorporated into the formula.

5. Optimizing particle packing, and minimizing overall particulate surface area, reduce the amount of resin required to manufacture an engineered stone part.

6. Fissures in natural stone are filled with resin using a lower pressure, i.e. a vacuum, rather than elevated pressures.

7. The use of vacuum casting is the preferred method and reduces the resin content needed to manufacture engineered stone parts.

8. The removal of resin on the top side and the compaction of the matrix before vibration reduces the possibility of warping caused by the settling of the larger stone particulate.

While the preferred embodiments of the present invention have been illustrated in detail, it should be apparent that modifications and adaptations to those embodiments may occur to one skilled in the art without departing from the scope of the present invention.

I claim:

1. A polymerizable composition comprising:
a monoethylenically unsaturated resin polymerizable by a free radical initiator; and
a particulate formulation comprising one or more gemstones, wherein said gemstones are present at a level between about 0.5 weight percent to about 30 weight percent of said particulate formulation.

2. The composition of claim 1, wherein said particulate formulation further comprises quartz.

3. The composition of claim 1, wherein said gemstones arc selected from the group consisting of citrine, lapis, Peridot, jade, garnet, amethyst, calcite, hematite, tiger's eye, citrine, obsidian, garnet, and combinations thereof.

4. The composition of claim 3, wherein said gemstones comprise visually translucent crystals.

5. The composition of claim 3, wherein said resin comprises an ester.

6. The composition of claim 5, wherein said ester is methylmethacrylate or unsaturated polyester resin.

7. The composition of claim 6 which comprises at least 75 percent by weight particulate formulation.

8. A translucent article formed by the composition of claim 4.

9. A polymerized article formed by the composition of claim 1.

10. The polymerized article of claim 9 as a countertop.

11. A method for casting or molding a polymerizable composition comprising:
mixing a composition comprised of a monoethylenically unsaturated resin polymerizable by a free radical initiator, a free radical initiator, and a particulate formulation comprising one or more gemstones present at a level between about 0.5 weight percent to about 30 weight percent;
casting or molding the composition; and
curing the composition.

12. The method of claim 11, wherein said gemstones are selected from the group consisting of citrine, lapis, Peridot, jade, garnet, amethyst, calcite, hematite, tiger's eye, citrine obsidian, garnet, and combinations thereof.

13. The method of claim 12, wherein said gemstones comprise visually translucent crystals.

14. The method of claim 12, wherein said particulate formulation further comprises quartz.

15. The method of claim 11, wherein said composition further comprises:
an epoxide; and
a phosphoric acid ester.

16. The method of claim 11, wherein said mixing step comprises:
disposing said particulate formulation in a vessel comprising a liquid injection port;
reducing the pressure inside said vessel to 20-25 inches of vacuum;
injecting an initiated or uninitiated resin into said vessel;
mixing said resin and said particulate formulation until the resin is uniformly distributed throughout the particulate formulation;
opening said vessel to ambient air;
adding one or more polymerization initiators;
reducing the pressure inside said vessel
mixing said resin/particulate formulation/catalysts mixture until the one or more polymerization catalysts are uniformly distributed throughout.

17. The method of claim 18, wherein said casting step comprises:
providing a mold defining the shape of an article;
disposing the resin/particulate formulation/initiators mixture into said mold;
placing a filter layer over the top of said mold, wherein the filter layer is permeable to the resin/particulate formulation/catalysts mixture;
reducing the pressure on the top side of said mold;
removing excess resin/particulate formulation/initiators mixture from said mold;.

18. The method of claim 19, wherein said curing step comprising heating said mold to a temperature sufficient to activate the one or more polymerization catalysts.

19. The method of claim 18, further comprising removing a molded article from said mold.
